(19) United States
(12) Patent Application Publication
(10) Pub. No.: US 2026/0162979 A1
(43) Pub. Date: Jun. 11, 2026

(54) DISORDERED CATHODE FOR A BATTERY

(71) Applicant: Nissan North America, Inc., Franklin, TN (US)

(72) Inventors: Albert Wang Xiao, Yokohama (JP); Simran Kumari, Santa Clara, CA (US); Balachandran Gadaguntla Radhakrishnan, San Jose, CA (US); Masanobu Uchimura, Palo Alto, CA (US); Shigemasa Kuwata, Palo Alto, CA (US); Manas Likhit Holekevi Chandrappa, Sunnyvale, CA (US)

(21) Appl. No.: 18/977,359

(22) Filed: Dec. 11, 2024

(51) Int. Cl. H01M 4/505; C01B 33/32; C01G 45/1242; C01G 49/00

(52) U.S. Cl. CPC H01M 4/505; C01B 33/32; C01G 45/1242; C01G 49/0072; C01P 2002/32; C01P 2002/50; C01P 2002/72; C01P 2006/40

(57) ABSTRACT

A cathode material includes a cation disordered composition comprising a spinel crystal structure and the following formula: Li_{1+y}Mn_{2—x}AₓO_{4+z}, where 0.0<x≤0.5, z and y are ≤0.5, and A comprises Y, Zr, Si, V, Nb, Fe, Cu, Ti, or any combination thereof. A may be introduced into the cathode material by elemental substitution.

### TECHNICAL FIELD

This disclosure relates to Lithium Manganese Oxide cathode materials that have a spinel crystal structure and are disordered.

### BACKGROUND

In the current state of batteries, alternatives to nickel and cobalt in cathodes are constantly being investigated to determine if more cost effective and widely available materials can achieve desirable output and cycle properties. In addition, materials are being tested and identified that have sufficient charging capacity, charging speed, and that are useable with current battery chemistry schemes. Lithium Manganese Oxide (LMO) cathode materials have been identified as a material with the potential to meet the above needs. However, common LMO cathode materials suffer from a sharp two-phase transition during voltage discharge that is slow, limits rate capability, and mechanically stresses the cathode material. Accordingly, what is needed are LMO cathode materials that do not suffer from the sharp two-phase transition and can meet total capacity, cycle capacity, and stability within targeted battery chemistries.

### SUMMARY

Disclosed herein are implementations of a cathode material including a cation disordered composition including a spinel crystal structure and the following formula:

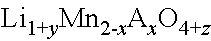

where 0.0<x≤0.5,
where z and y are ≤0.5, and
where A comprises Y, Zr, Si, V, Nb, Fe, Cu, Ti, or any combination thereof.

The cathode material may include Y, Zr, V, Si, Nb, or any combination thereof. The A of the formula may consists essentially of Y, Zr, or both. The cathode material may have the following amounts 0.0<x≤0.25, wherein z and y are ≤0.25. The cation disordered composition may have an energy above hull of 0.130 eV/atom or less. The disordered cathode material may be essentially free of Ni, Co, or both.

The cation disordered composition may have an X-ray diffraction pattern having an area ratio of less than 0.800 at peaks of 36.0-36.6° (2θ) to 43.8-44.5° (2θ), as measured by Cu kα radiation. The cation disordered composition may have a cell potential in a lithium-ion battery cell that exhibits a sloping character such that the percentage of total capacity observed between 3.9 and 2.9 V vs. Li+/Li is at least 5%. The A of the above formula may be integrated into the cation disordered composition by elemental substitution.

The present disclosure provides disordered cathode materials that reduce or eliminate the two-phase transition during discharge of LMO materials through substitution of one or more elements in the spinel crystal structure to form an LiMnAO material, where “A” is a desirable metal or silicon. Chemical substitution (e.g., by chemical decomposition of mixed precursors) reliably substitutes elements into the spinel crystal structure to create energetically stable or metastable spinel crystal structures, where the Mn may be displaced to other crystal positions and replaced with the substituted element. After substitution, the LiMnAO exhibits a sloping profile and gradual transition during cell discharge (i.e., cell potential compared to capacity), which is desirable to reduce mechanical degradation and capacity fade in cathode materials including LMO by avoiding the sharp two-phase transition.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-section schematic view of a lithium battery cell as disclosed herein.

FIG. 2 illustrates a graph of cell potential compared to capacity during cycling of cell charge and discharge of a LiMn₂O₄ cathode material.

FIG. 3 illustrates a graph of cell potential compared to capacity during cycling of cell charge and discharge of a Li₁Mn_{1.75}Zr_{0.25}O₄ cathode material.

FIG. 4 illustrates a graph of cell potential compared to capacity during cycling of cell charge and discharge of a Li_{1.2}Mn_{1.75}Zr_{0.25}O₄ cathode material.

FIG. 5 illustrates a graph of cell potential compared to capacity during cycling of cell charge and discharge of a Li₁Mn_{1.75}Si_{0.25}O₄ cathode material.

FIG. 6 illustrates a graph of cell potential compared to capacity during cycling of cell charge and discharge of a Li₁Mn_{1.75}Al_{0.25}O₄ cathode material.

FIG. 7 illustrates a graph of cell potential compared to capacity during cycling of cell charge and discharge of a Li₁Mn_{1.75}Nb_{0.25}O₄ cathode material.

FIG. 8 illustrates a graph of cell potential compared to capacity during cycling of cell charge and discharge of a Li₁Mn_{1.75}Fe_{0.25}O₄ cathode material.

FIG. 9 illustrates a graph of cell potential compared to capacity during cycling of cell charge and discharge of a Li₁Mn_{1.75}Cu_{0.25}O₄ cathode material.

FIG. 10 illustrates a graph of cell potential compared to capacity during cycling of cell charge and discharge of a Li₁Mn_{1.75}Ti_{0.25}O₄ cathode material.

FIG. 11 illustrates a graph of cell potential compared to capacity during cycling of cell charge and discharge of a Li₁Mn_{1.75}V_{0.25}O₄ cathode material.

FIG. 12 illustrates a graph of cell potential compared to capacity during cycling of cell charge and discharge of a Li₁Mn_{1.75}Y_{0.25}O₄ cathode material.

FIGS. 13A-13B illustrate graphs of normalized discharge capacity over cycle number for various metals substituted into the lithium manganese oxide cathode material.

FIG. 14 illustrates a graph of energy above hull for different substitutions of metals in the lithium manganese oxide cathode materials.

FIG. 15 illustrates a X-Ray Diffraction data for different substitutions of elements in the lithium manganese oxide cathode materials.

### DETAILED DESCRIPTION

Lithium Manganese Oxide (LMO) can be organized into spinel crystal structures that provide desirable battery properties. When introducing disorder into the spinel crystal structures, the Manganese (Mn) is displaced from the 16d position to the 16c position in the crystal lattice, which can reduce the sharp two-phase transition during cell discharge. Chemical decomposition of lithium and manganese containing starting materials with appropriate metals or silicon to form a substituted LMO (i.e., LiMnAO structure, where A is the appropriate metal or silicon) results in substituted spinel crystal lattice structures, where displacement of some of the Mn from 16d to 16c in the lattice structure is stabilized, without the negative mechanical impacts on the particles of high energy stresses during formation of the LMO or substituted LMO cathode material by other means, such as exclusively by high energy ball milling.

The displacement of the Mn between positions is stabilized through introduction of a specific element during chemical substitution (e.g., chemical decomposition). Metals, such as Vanadium (V), Copper (Cu), Yttrium (Y), Zirconium (Zr), Niobium (Nb), Iron (Fe), Titanium (Ti) or any combination thereof, and/or silicon are introduced into spinel crystal structure and create the disorder in the crystal structure by displacing Mn ions. The increased disorder allows for a sloping characteristic in the voltage vs. capacity curve during cell cycling and a gradual shift between the voltage plateaus in addition to improved capacity features. By avoiding a sharp two-phase shift during cycling, mechanical stress and capacity fade is reduced in the cathode material.

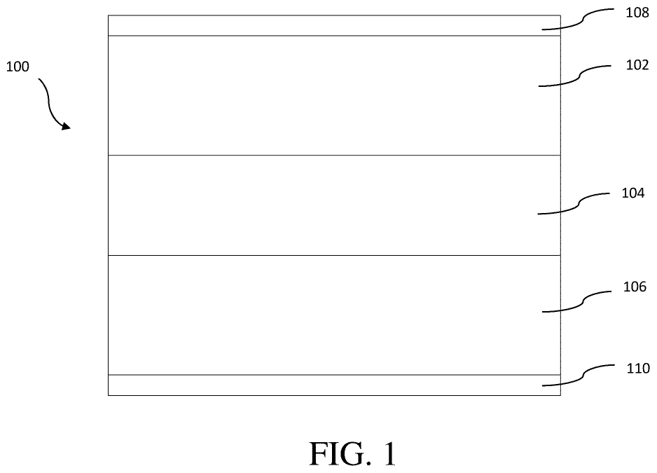

A lithium battery cell 100 is illustrated schematically in cross-section in FIG. 1. The lithium battery cell 100 of FIG. 1 is configured as a layered battery cell that includes as active layers a cathode active material layer 102 having the disorder spinel crystal structures as described herein, an electrolyte 104, and an anode active material layer 106. In some embodiments, such as lithium batteries using a liquid or gel electrolyte, the lithium battery cell 100 may include a separator interposed between the cathode active material layer 102 and the anode active material layer 106. In addition to the active layers, the lithium battery cell 100 of FIG. 1 may include a cathode current collector 108 and an anode current collector 110, configured such that the active layers are interposed between the anode current collector 110 and the cathode current collector 108. In such a configuration, the cathode current collector 108 is adjacent to the cathode active material layer 102, and the anode current collector 110 is adjacent to the anode active material layer 106. A lithium battery can be comprised of multiple lithium battery cells 100.

The anode active material in the anode active material layer 106 of a lithium metal battery can be a layer of elemental lithium metal, a layer of a lithium compound(s) or a layer of doped lithium. The anode active material in the anode active material layer 106 of a lithium-ion battery can be a layer graphite or a silicon-based material. In some embodiments, the disordered cathode materials may be used in an anode free battery where the anode layer is formed during charging form the lithium contained in the cathode. Other anode active materials known to those skilled in the art can be used. The anode current collector 110 can be, as a non-limiting example, a sheet or foil of copper, nickel, a copper-nickel alloy, carbon paper, or graphene paper.

In lithium batteries, the electrolyte 104 may include a liquid electrolyte, a polymer ionic liquid, a gel electrolyte, or a combination thereof. The electrolyte can be an ionic liquid-based electrolyte mixed with a lithium salt. The ionic liquid may be, for example, at least one selected from N-Propyl-N-methylpyrrolidinium bis(flurosulfonyl)imide, N-methyl-N-propylpyrrolidinium bis(trifluoromethanesulfonyl)imide, N-butyl-N-methylpyrrolidinium bis(trifluoromethylsulfonyl)imide, 1-butyl-3-methylimidazolium bis(trifluoromethylsulfonyl)imide, and 1-ethyl-3-methylimidazolium bis(trifluoromethylsulfonyl)imide. The salt can be or include, for example, a fluorosulfonyl (FS0) group, e.g., lithium bisfluorosulfonylimide (LiN(FS0₂)₂, (LiFSI), LiN(FS0₂)₂, LiN(FS0₂) (CF₃S0₂), LiN(FS0₂)(C₂F₅S0₂) . In some embodiments, the electrolyte is or includes a cyclic carbonate (e.g., ethylene carbonate (EC) or propylene carbonate, a cyclic ether such as tetrahydrofuran (THF) or tetrahydropyran (TH), a glyme such as dimethoxyethane (DME) or diethoxyethane, an ether such as diethylether (DEE) or methylbutylether (MBE), their derivatives, and any combinations and mixtures thereof. Where a separator is used, such as with a liquid or gel electrolyte, the separator can be a polyolefine or a polyethylene, as non-limiting examples.

In an all solid state battery (ASSB), the electrolyte 104 is solid. The solid electrolyte can be, as non-limiting examples, sulfide compounds (e.g. Argyrodite, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO).

Specific disordered cathode materials may have any spinel crystal structure arrangement sufficient to achieve desirable battery properties. The cathode material may have the following formula:

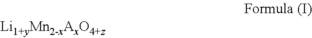

Where A is Y, Zr, Si, V, Nb, Fe, Cu, Ti, or any combination thereof. A may be free of any aluminum, cobalt, nickel, or any combination thereof.
where y is zero or less than 0.5;
where x is greater than zero and less than between 0.5 and 0.01; and
where z is zero or between −0.5 and 0.5.

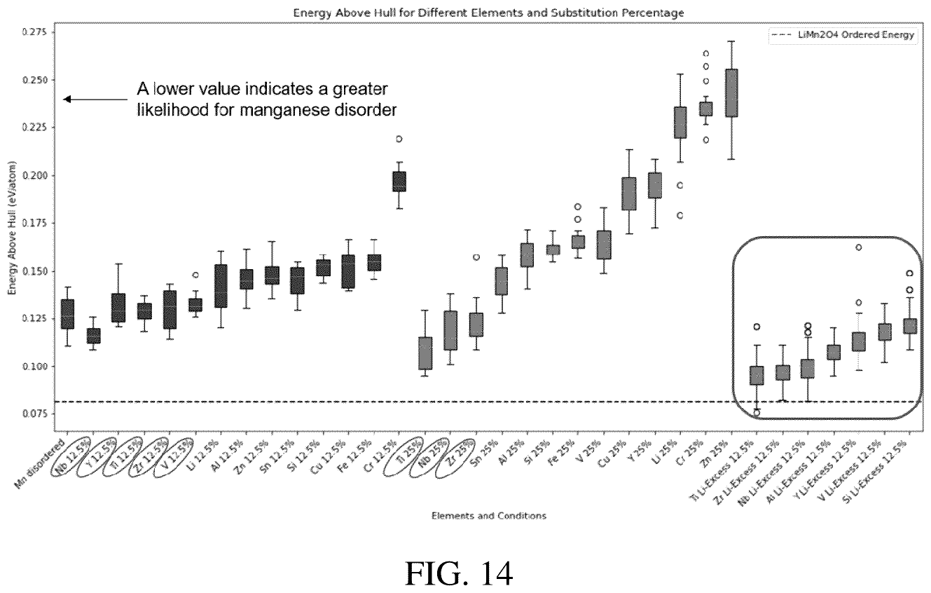

The degree that the cathode material is disordered may be determined by energy above hull for a certain substitution amount within the LMO spinel crystal structure. A lower energy above hull may indicate a greater likelihood of manganese disorder in a substituted LMO structure. The substituted LMO formula may include an excess of lithium such that the overlithiated and substituted and disordered LMO has a lower energy above hull and, without being bound by any theory, lithium ions may fill voids of the displaced Mn ions. The substituted LMO may include any amount of substituted metal or silicon (i.e., A) in the LiMnAO sufficient to achieve a lower energy above hull for the disordered LMO structure. By percentage, the substituted LiMnOA may include a metal other than manganese about 10%, 12.5%, or 15% to about 22.5%, 25%, or 27.5%. The substituted LMO formula may have an energy above hull of about 0.150 or less, about 0.140 or less, about 0.130 or less, about 0.120 or less, about 0.110 or less, or about 0.100 or less. Energy above hull may be calculated by known computational methods and experimental techniques. FIG. 14 illustrates computation results of different elemental substitutions. A lower value indicates a greater likelihood of disorder. As illustrated, Nb, Y, Zr, V, Ti, and Zr, which may also be influenced by over lithiation (see right side of FIG. 14), may indicate a higher level of disorder by being below about 0.130 eV/atom.

The disordered cathode material may be made from any starting components sufficient to achieve the spinel crystal structure of the substituted LMO. For example, one or more lithium precursors, manganese precursors, and substituted metal precursors may be mixed in appropriate stochiometric ratios to achieve the desired substituted LMO and/or lithiation. Lithium precursors may include one or more of lithium carbonate (Li₂CO₃), lithium nitrate (LiNO₃), lithium acetate (LiC₂H₃O₂), lithium hydroxide (LiOH), or combinations thereof. Manganese precursors may include one or more of manganese dioxide (MnO₂), manganese nitrate (Mn(NO₃)₂), manganese sulfate (MnSO₄₃), manganese acetate (Mn(C₂H₃O₂)₂), manganese chloride (MnCl₂), manganese acetate ((CH₃CO₂)₂), or combinations thereof. Substitution metal precursors may include one or more of Vanadium (V), Copper (Cu), Yttrium (Y), Zirconium (Zr), Niobium (Nb), Iron (Fe), Titanium (Ti), or any combination thereof and one or more appropriate counterions. Appropriate counterions may include one or more oxides, acetates, nitrates, or any combination thereof. In some examples, the substitution metal precursor includes one or more of zirconium(IV) isopropoxide, niobium(V) ethoxide, aluminum isopropoxide, iron(III) nitrate, copper(II) acetate, yttrium(III) acetate, vanadium(V) oxytriisopropoxide, any combination thereof.

Mixing of the lithium precursors, manganese precursors, and substitution metal precursors may be conducted in an appropriate mixing solvent, gelling agent, or both. Mixing solvents may include one or more of water, ethanol, methanol, propanol, butanol, or any combination thereof. Gelling agents may include one or more chelating agents (e.g., citric acid or ethylene glycol). Solvents and/or gelling agents may be removed during a drying step to form a sol-gel precursor before chemical decomposition or other chemical substation techniques.

Disorder of the cathode material can be achieved through any means sufficient to displace at least some of the manganese in the spinel crystal structure. Displacement of manganese may move the manganese atoms from the 16d to the 16c position of the spinel crystal structure. As described throughout, disorder may be formed by displacement of the manganese from the 16d to the 16c positions and filling the voids in the 16d positions with substituted metal or silicon ions (other than manganese) and/or lithium ions. Disorder may be introduced by chemically altering, or optionally in combination with mechanically altering, the spinel crystal structure of the cathode material. In some examples, only chemical substitution is used to achieve disorder in the cathode material so that high mechanical stresses on the particles of the cathode material from mechanical altering, such as high energy ball milling, are avoided. Chemically altering the crystal structure may be achieved through decomposition of a sol-gel precursor, as described herein. Generally, mechanical altering may be conducted by high energy ball milling. In some examples, combinations of chemical and/or mechanical altering may be desired to achieve sufficient disorder to introduce the metal into the LMO crystal structure, which may reduce or eliminate the two-phase transition during cycling.

Chemically altering the crystal structure of the cathode material may be conducted such that desired metals are substituted into the crystal structure and displace some of the Mn ions from 16d to 16c positions in the crystal structure. Chemical altering may include mixing starting components into a substantially homogenous mixture or solution of starting components and appropriate solvents and drying the homogenous mixture or solution under vacuum and/or elevated temperature to remove solvents and to form a sol-gel precursor. Then, the sol-gel precursor is ground, and heat is applied to the ground sol-gel precursor to yield the substituted LMO. When heating the sol-gel precursor, the heat may be applied to a temperature of about 200 degrees Celsius, about 300 degrees Celsius, or about 500 degrees Celsius to about 800 degrees Celsius, 1000 degrees Celsius, or about 1200 degrees Celsius.

The cathode material may provide lithium battery cells with capacities greater than 130 mAh/g to about 230 mAh/g. The cathode material may provide lithium battery cells that operate between 4.5 V or 3.9 V to 2.9 V or 1.5 V. The cell potential of the cathode composition in a lithium ion battery cell may exhibit a sloping character such that the percentage of total capacity observed between 3.9 and 2.9 V vs. Li+/Li is greater than the percentage of total capacity of an unsubstituted or a non-disordered LMO crystal structure. For example, the percentage of total capacity observed may be about, about 4% or more, about 5% or more, about 6% or more, about 7% or more, or about 8 percent or more.

Disorder may be determined through an X-Ray Diffraction (XRD) pattern that decreases with increasing disorder in the material. XRD may be analyzed by a Rigaku Miniflex X-ray diffractometer instrument. In the XRD, a 311 peak (i.e., generally a peak at 36-36.6) may be associated with the spinel peak. A 400 peak (i.e., generally a peak at 40-44.6) may be associated with a disordered rocksalt peak. By analyzing the full width at half maximum (FWHM) under each curve, a spinel crystal structure to rocksalt ratio can be determined. Where the ratio is 0.810 or less, 0.800 or less, or 0.790 or less, and a suitable metal is substituted into the spinel crystal structure, the cathode material may be sufficiently disordered to reduce or eliminate the two-phase transition during battery cycling.

Unless otherwise defined, all technical and scientific terms used have the same meaning as commonly understood by one of ordinary skill in the art to which the claimed subject matter belongs. The terminology used in this description is for describing particular embodiments only and is not intended to be limiting. As used in the specification and appended claims, the singular forms “a,” “an,” and “the” are intended to include the plural forms as well, unless the context clearly indicates otherwise.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

### EXAMPLES

The following examples are illustrative of some of the inventive concepts of this disclosure and not meant to limit the scope of the claims.

### Synthesis of Materials

The cathode materials having the following formula may be formulated through the following techniques:
Li_{1+y}Mn_{2—x}AₓO_{4+z} synthesis:
where x, y, and z are defined herein and by the following experimental setup.

The synthesis of substituted lithium manganese spinel is performed via the thermal decomposition of a sol-gel precursor. The synthesis of a Zr substituted sample (LiMn_{1.75}Zr_{0.25}O₄) is described as follows. First, 20 mmol of lithium acetate (1.32 g), 35 mmol manganese(II) acetate (8.578 g), and 30 mmol of citric acid (5.76 g) is dissolved in 150 mL of deionized water in a 500 mL beaker. Next, 5 mmol of zirconium(IV) isopropoxide (1.64 g) dissolved in 50 mL of isopropanol is added to the beaker, and the mixture is ultrasonicated, stirred and a heated at 80° C. for 1 hr. The resulting liquid mixture is subsequently dried under vacuum at 80° C. to remove the remaining solvents and form the finished sol-gel precursor. The sol-gel precursor is then ground in a mortar and pestle and heated in a furnace to between 300° C. and 800° C. for up to 4 hours to form the LiMn_{1.75}Zr_{0.25}O₄ active material. Other substituted samples are prepared following a similar procedure, where the 5 mmol of zirconium(IV) isopropoxide replaced by 5 mmol of a different precursor, corresponding to the element to be substituted. In the case of niobium, niobium(V) ethoxide is used; in the case of aluminum, aluminum isopropoxide is used; in the case of iron, iron(III) nitrate is used; in the case of copper, copper(II) acetate is used; in the case of yttrium, yttrium(III) acetate is used; in the case of vanadium, vanadium(V) oxytriisopropoxide is used; in the case of silicon, tetraethoxysilane is used; in the case of titanium, titanium(IV) isopropoxide is used; and in the case of the non-substituted LiMn2O4 the amount of manganese(II) acetate is increased to 35 mmol. The degree of substitution is adjusted by varying the amounts of manganese(II) acetate and the substituent element precursor, and in all cases the sum of both compounds should equal 40 mmol.

### Electrochemical Testin:

In order to perform electrochemical tests on the Li_{1+y}Mn_{2—x}AₓO_{4+z} active materials in a lithium ion battery cell, the Li_{1+y}Mn_{2—x}AₓO_{4+z} active materials are first fabricated into a battery cathodes using a slurry coating method. The as-synthesized active material is mixed with a conductive carbon (i.e. acetylene black) and a polyvinylidene fluoride binder in a 8:1:1 ratio by mass, followed the addition of N-methyl-2-pyrrolidone solvent to form a viscous slurry. The slurry is then mechanically mixed until uniform and cast onto an aluminum foil current collector using a blade coating machine (doctor blade). The resulting coated foils are then dried under flowing air for up to 12 hrs, before being further dried under vacuum at 80° C. for 2 hrs to yield the finished cathodes.

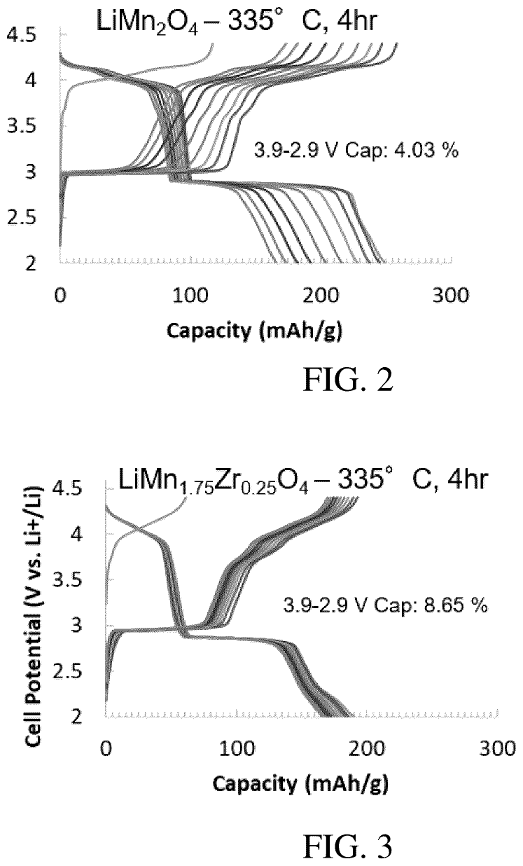

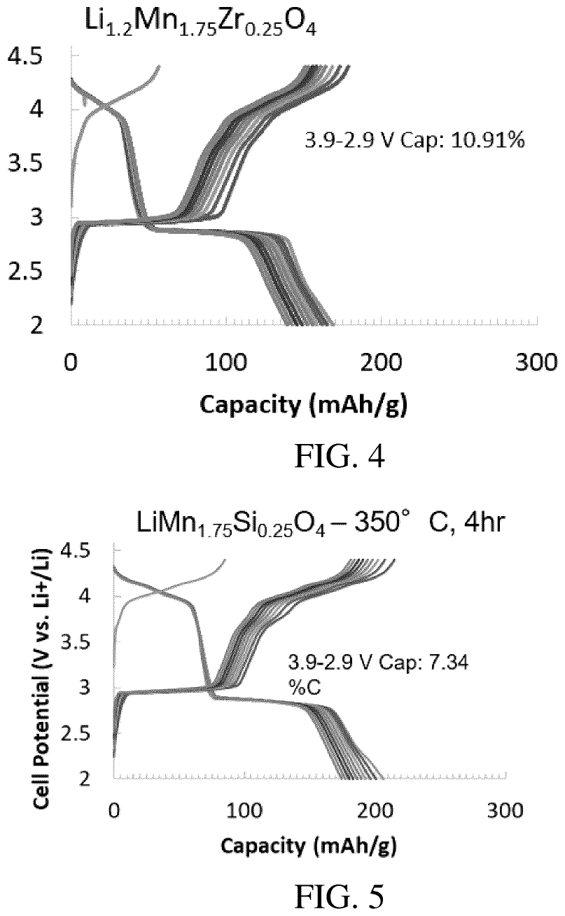

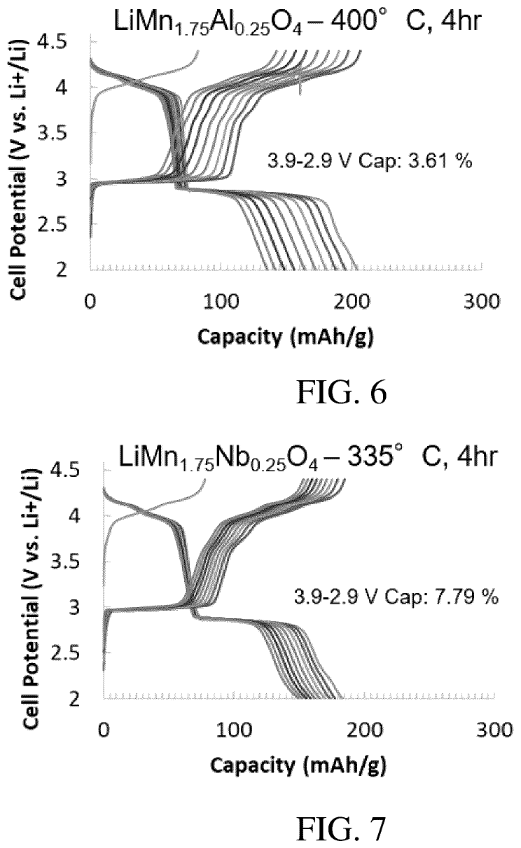

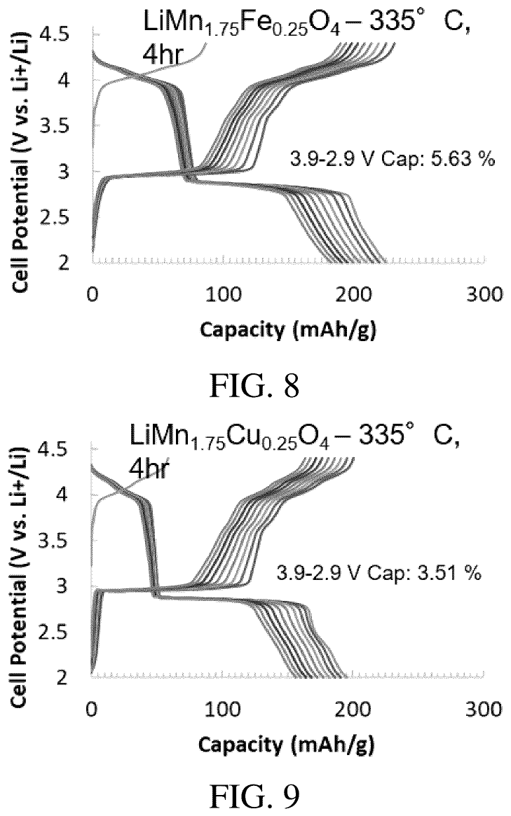

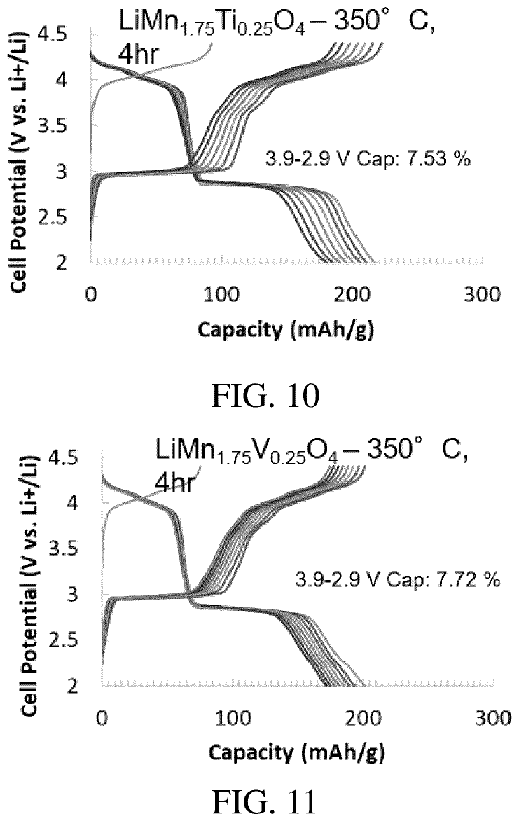

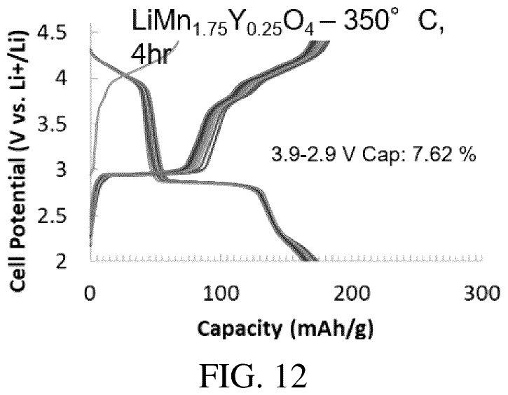

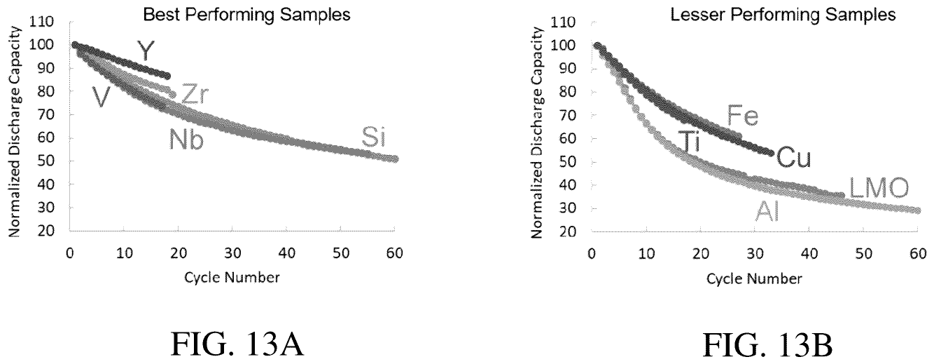

The as-prepared cathodes are then cut into 1 cm diameter discs and assembled into a 2032 coin-type cell using a metallic lithium foil as the anode, a 1 M solution of lithium hexafluorophosphate (LiPF₆) in a mixture of ethylene carbonate, and dimethyl carbonate as the electrolyte, and a porous glass fiber sheet as the separator. The resulting test cells is then subject to constant current charge/discharge tests using a Biologic VMP-3 potentiostat with a constant current of C/20. Results are shown in FIGS. 2-12. The FIGS. 4-5, 7-8, and 10-12 illustrate that substitution of various metals in the LMO crystal structure, which each reduce the sharp two-phase transition during cycling, as shown by the 3.9-2.9 V Cap increase above 4 %. On the other hand, aluminum and copper, shown in FIGS. 6 and 9 respectively, illustrate performance that is about the same as or worse than the unsubstituted LMO of FIG. 2. FIG. 3 illustrates substitution of Zr and overlithiation of the LMO crystal structure, which also significantly reduces the sharp two-phase transition. Additionally, FIGS. 13A-13B illustrate the normalized discharge capacity v. cycle number of various metals after substitution in the LMO spinel crystal structure. As seen from FIGS. 13A-13B, performance is increased by substituting Iron, Copper, Titanium, Zirconium, Niobium, Yttrium, Silicon, and Vanadium over substitution with Aluminum or no substitution (i.e., LMO) in the LMO spinel crystal structure.

### Structural Characterization

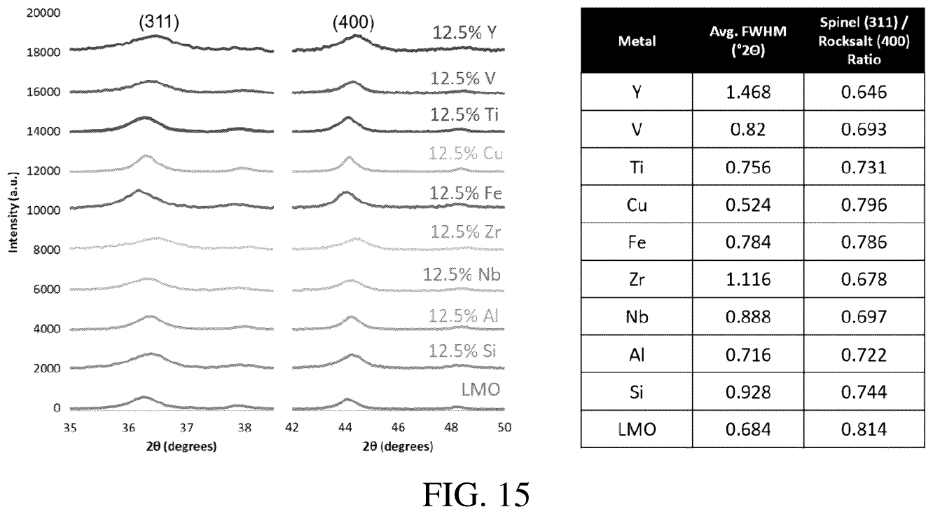

X-ray diffraction patterns of the as-synthesized cathode active materials are collected using a Rigaku Miniflex X-ray diffractometer. Samples are prepared by placing the as-synthesized powder onto a low-background silicon sample holder. The diffraction pattern is measured using Cu kα radiation from 10-90° 2θ (2 -theta) at a scan rate of 3° 2θ per second. Results are shown in FIG. 15. As seen from FIG. 15, elements with high disorder can be determined by a desirable spinel/rocksalt peak ratio, such as below 0.800, compared to the LMO X-ray diffraction pattern.

What is claimed is:

1. A cathode material, comprising:
a cation disordered composition comprising a spinel crystal structure and the following formula: 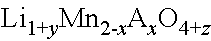
wherein 0.0<x≤0.5,
wherein z and y are ≤0.5, and
wherein A comprises Y, Zr, Si, V, Nb, Fe, Cu, Ti, or any combination thereof.

2. The cathode material of claim 1, wherein A comprises Y, Zr, V, Si, Nb, or any combination thereof.

3. The cathode material of claim 1, wherein A comprises Y, Zr, or both.

4. The cathode material of claim 3, wherein 0.0<x≤0.25, wherein z and y are ≤0.25.

5. The cathode material of claim 4, wherein the cation disordered composition has an energy above hull of 0.130 eV/atom or less.

6. The cathode material of claim 1, wherein A consists essentially of Y, Zr, or both.

7. The cathode material of claim 1, wherein the cathode disordered composition is essentially free of Ni, Co, or both.

8. The cathode material of claim 1, wherein the cation disordered composition having an X-ray diffraction pattern having an area ratio of less than 0.800 at peaks of 36.0-36.6° (2θ) to 43.8-44.5° (2θ), as measured by Cu kα radiation, or
wherein the cation disordered composition has a cell potential in a lithium-ion battery cell that exhibits a sloping character such that the percentage of total capacity observed between 3.9 and 2.9 V vs. Li+/Li is at least 4%.

9. The cathode material of claim 1, wherein A is integrated into the cation disordered composition by elemental substitution.

10. A cathode material, comprising:
a cation disordered composition comprising a spinel crystal structure and the following formula: 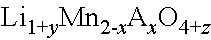
wherein 0.0<x≤0.5,
wherein z and y are ≤0.5, and
wherein A comprises Y, Zr, Si, V, Nb, Fe, Cu, Ti, or any combination thereof,
wherein the cation disordered composition having an X-ray diffraction pattern having an area ratio of less than 0.800 at peaks of 36.0-36.6° (2θ) to 43.8-44.5° (2θ), as measured by Cu kα radiation.

11. The cathode material of claim 10, wherein 0.0<x≤0.25, and wherein z and y are ≤0.25.

12. The cathode material of claim 10, wherein 0.1≤x≤0.5, 0.0≤y≤0.25, and −0.25<z<0.25.

13. The cathode material of claim 10, wherein A comprises Y, Zr, V, Si, Nb, or any combination thereof.

14. The cathode material of claim 10, wherein A comprises Y or Zr.

15. The cathode material of claim 14, wherein the disordered cathode material is essentially free of Ni, Co, or both.

16. A cathode material, comprising:
a cation disordered composition comprising a spinel crystal structure and the following formula: 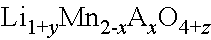
wherein 0<x≤0.5,
wherein z and y are ≤0.5,
wherein A comprises Y, Zr, Si, V, Nb, Fe, Cu, Ti, or any combination thereof, and
wherein the cation disordered composition has a cell potential in a lithium-ion battery cell that exhibits a sloping character such that the percentage of total capacity observed between 3.9 and 2.9 V vs. Li+/Li is at least 4%.

17. The cathode material of claim 16, wherein 0<x≤0.25, and wherein z and y are ≤0.25.

18. The cathode material of claim 16, wherein the cation disordered composition has a cell potential in a lithium-ion battery cell that exhibits a sloping character such that the percentage of total capacity observed between 3.9 and 2.9 V vs. Li+/Li is at least 4.5%.

19. The cathode material of claim 16, wherein A comprises Y, Zr, V, Si, Nb, or any combination thereof.

20. The cathode material of claim 19, wherein the disordered cathode material is essentially free of Ni, Co, or both.
